(19) United States
(12) Patent Application Publication
(10) Pub. No.: US 2025/0358209 A1
(43) Pub. Date: Nov. 20, 2025

(54) PROBABILISTIC PROBE RESPONSE

(71) Applicant: Ruckus IP Holdings LLC, Claremont, NC (US)

(72) Inventors: Yang Han, Singapore (SG); Shailesh Gupta, Bengaluru (IN); See Ho Ting, Singapore (SG)

(73) Assignee: Ruckus IP Holdings LLC, Claremont, NC (US)

(21) Appl. No.: 19/205,260

(22) Filed: May 12, 2025

Related U.S. Application Data
(60) Provisional application No. 63/647,258, filed on May 14, 2024.

(51) Int. Cl. H04L 43/12; H04W 24/08

(52) U.S. Cl. CPC H04L 43/12; H04W 24/08

(57) ABSTRACT

An electronic device (such as an access point) is described. This electronic device includes an interface circuit that wirelessly communicates with a second electronic device. During operation, the electronic device may receive, from the interface circuit, a probe request associated with the second electronic device, where the probe request includes an identifier of the second electronic device (such as a media access control or MAC address). In response, the electronic device may probabilistically provide, from the interface circuit, a probe response addressed to the second electronic device, where the probabilistically providing has a probability that is based at least in part on a communication-performance metric associated with the probe request, a predefined minimum value of the communication-performance metric and a predefined maximum value of the communication-performance metric.

### CROSS REFERENCE TO RELATED APPLICATIONS

This application claims priority under 35 U.S.C. 119(e) to U.S. Provisional Application Ser. No. 63/647,258, “Probabilistic Probe Response,” filed on May 14, 2024, by Yang Han et al., the contents of which are herein incorporated by reference.

### FIELD

The described embodiments relate to techniques for probabilistically providing a probe response.

### BACKGROUND

Many electronic devices are capable of wirelessly communicating with other electronic devices. For example, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard (which is sometimes referred to as ‘Wi-Fi’), Bluetooth™ from the Bluetooth Special Interest Group of Kirkland, Washington), and/or another type of wireless network.

When an electronic device (or client) tries to connect to a Wi-Fi network, it often identifies available access points in a wireless local area network (WLAN) by performing an active scan for nearby operating access points. Notably, the electronic device may transmit a probe request. In response to receiving a probe request, an access point typically transmits a probe response. The client may use one or more received probe responses to identify a target access point. Then, the client may attempt to connect to the target access point.

However, under certain circumstances, the number of probe responses may increase drastically. For example, the number of probe responses increases when: an access-point density increases, a number of WLANs increases and/or a number of clients increases. An excessive number of probe responses may significantly increase the airtime utilization associated with access points and, thus, may adversely affect the overall network performance.

### SUMMARY

An electronic device (such as an access point) is described. This electronic device includes an interface circuit that wirelessly communicates with a second electronic device. During operation, the electronic device receives, from the interface circuit, a probe request associated with the second electronic device, where the probe request includes an identifier of the second electronic device (such as a media access control or MAC address). In response, the electronic device probabilistically provides, from the interface circuit, a probe response addressed to the second electronic device, where the probabilistically providing has a probability that is based at least in part on a communication-performance metric associated with the probe request, a predefined minimum value of the communication-performance metric and a predefined maximum value of the communication-performance metric.

Note that the communication-performance metric may include a signal strength associated with the probe request, such as a received signal strength indication (RSSI).

Moreover, the predefined minimum value and the predefined maximum value may be based at least in part on an inter-electronic device communication-performance metric associated with communication between the electronic device and at least a neighboring electronic device. Furthermore, the inter-electronic device communication-performance metric may include a signal strength associated with the communication, such as an RSSI. Alternatively or additionally, the predefined minimum value and the predefined maximum value may be based at least in part on a density of the electronic device and the neighboring electronic device, and/or on a distance between the electronic device and the neighboring electronic device.

Furthermore, when the communication-performance metric has a smaller value, the probability of providing the probe response is reduced.

Another embodiment provides a computer-readable storage medium for use with the electronic device. This computer-readable storage medium may include program instructions that, when executed by the electronic device, cause the electronic device to perform at least some of the aforementioned operations.

Another embodiment provides a method. This method includes at least some of the operations performed by the electronic device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for probabilistically providing a probe response in accordance with an embodiment of the present disclosure.

FIG. 3 is a drawing illustrating an example of communication among electronic devices in FIG. 1 in accordance with an embodiment of the present disclosure.

FIG. 4 is a drawing illustrating an example of a wireless network in accordance with an embodiment of the present disclosure.

FIG. 5 is a drawing illustrating an example of a wireless network in accordance with an embodiment of the present disclosure.

FIG. 6 is a drawing illustrating an example of a probabilistic probe response in accordance with an embodiment of the present disclosure.

FIG. 7 is a drawing illustrating examples of probabilistic probe responses in accordance with an embodiment of the present disclosure.

FIG. 8 is a drawing illustrating an example of a wireless network in accordance with an embodiment of the present disclosure.

FIG. 9 is a drawing illustrating an examples of probabilistic probe responses in accordance with an embodiment of the present disclosure.

FIG. 10 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device (such as an access point) is described. This electronic device includes an interface circuit that wirelessly communicates with a second electronic device. During operation, the electronic device may receive, from the interface circuit, a probe request associated with the second electronic device, where the probe request includes an identifier of the second electronic device (such as a media access control or MAC address). In response, the electronic device may probabilistically provide, from the interface circuit, a probe response addressed to the second electronic device, where the probabilistically providing has a probability that is based at least in part on a communication-performance metric associated with the probe request, a predefined minimum value of the communication-performance metric and a predefined maximum value of the communication-performance metric.

By probabilistically providing the probe response, the communication techniques may reduce overhead and improve throughput and capacity (and, more generally, communication performance) in a wireless network. Moreover, the communication techniques may flexibly adapt to a wide variety of network conditions, such as different densities of access points, different numbers of WLANs and/or different numbers of clients. Consequently, the communication techniques may improve the user experience and customer satisfaction of users of the electronic device and/or the second electronic device.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

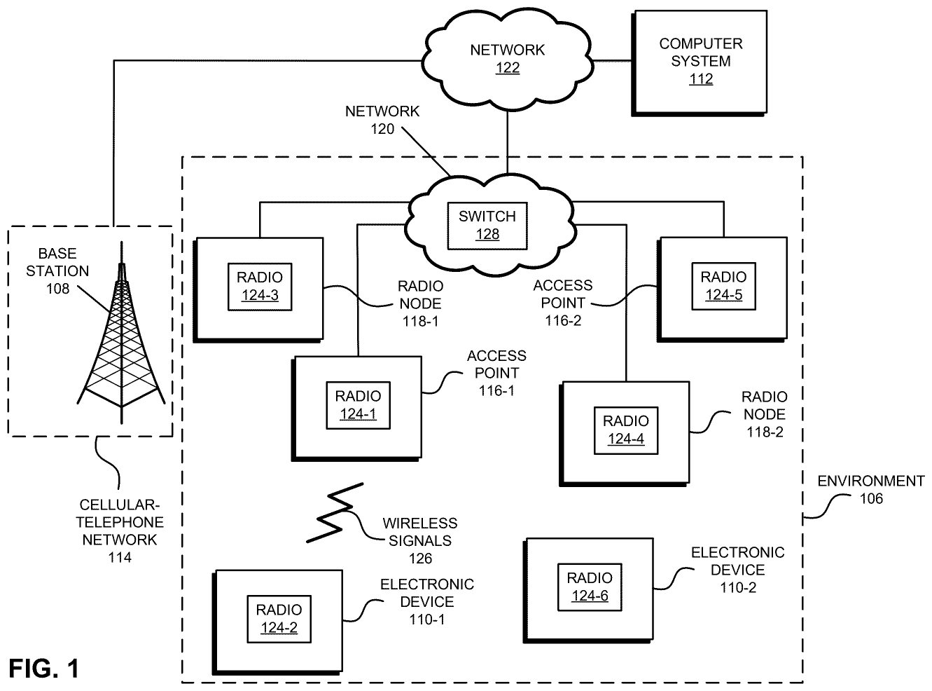

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or optional computer system 112 (which may include one or more computers, and which may be a local or cloud-based controller that manages and/or configures access points 116, radio nodes 118 and/or switch 128, or a cloud-based computer system that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

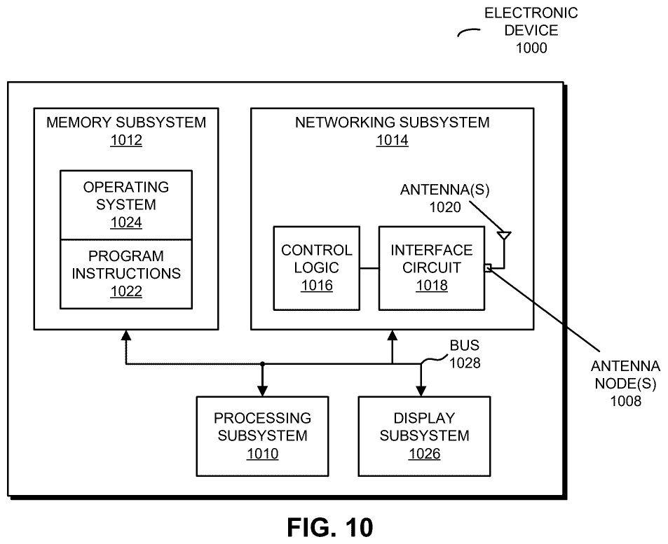

As described further below with reference to FIG. 10, electronic devices 110, computer system 112, access points 116, radio nodes 118 and switch 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHZ, 2.4 GHZ, 5 GHZ, 6 GHZ, 7 GHZ, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple input, multiple output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, existing probe-response suppression techniques may be inflexible and, thus, may not be able to adapt to different circumstances or configurations of a network (such as a wireless network). In order to address these problems, an access point (such as access point 116-1) may perform the communication techniques.

Notably, an electronic device (such as electronic device 110-1) may provide a probe request to access point 116-1. The probe request may include an identifier of electronic device 110-1 (such as a MAC address).

After receiving the probe request, access point 116-1 may probabilistically provide a probe response addressed to electronic device 110-1, where the probabilistically providing has a probability (between zero and one) that is based at least in part on a communication-performance metric associated with the probe request (such as an RSSI of the probe request at access point 116-1), a predefined minimum value of the communication-performance metric and a predefined maximum value of the communication-performance metric. For example, when the communication-performance metric has a smaller value, the probability of providing the probe response may be reduced. Note that access point 116-1 may determine the probability by performing a calculation using the communication-performance metric associated with the probe request, the predefined minimum value of the communication-performance metric and the predefined maximum value of the communication-performance metric. In some embodiments, prior to performing the calculation, access point 116-1 may access the predefined minimum value of the communication-performance metric and the predefined maximum value of the communication-performance metric in memory.

Prior to the calculation, access point 116-1 may determine the predefined minimum value of the communication-performance metric and the predefined maximum value of the communication-performance metric. Alternatively or additionally, prior to the calculation, computer system 112 may: collect or aggregate topology and/or historical data for access points 116; determine the predefined minimum value of the communication-performance metric and the predefined maximum value of the communication-performance metric based at least in part on the topology and/or the historical data; and provide, to access point 116-1, the predefined minimum value of the communication-performance metric and the predefined maximum value of the communication-performance metric.

In these ways, the communication techniques may reduce overhead and improve throughput and capacity (and, more generally, communication performance) in a network. Moreover, the communication techniques may flexibly adapt to a wide variety of network conditions, such as different densities of access points, different numbers of WLANs and/or different numbers of clients. Consequently, the communication techniques may improve the user experience and customer satisfaction of users of the electronic device and/or the second electronic device.

While the preceding discussion illustrated the communication techniques with access point 116-1, in other embodiments at least some of the operations in the communication techniques are performed by computer system 112.

In the described embodiments, processing a frame or a packet in a given one of the one or more access points 116 or a given one of the one or more electronic devices 110 may include: receiving wireless signals 126 with the frame or packet; decoding/extracting the frame or packet from the received wireless signals 126 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components. Therefore, in some embodiments there may be fewer or additional instances of at least some of the one or more access points 116, the one or more electronic devices 110 and/or computer system 112. As another example, in another embodiment, different electronic devices are transmitting and/or receiving frames or packets.

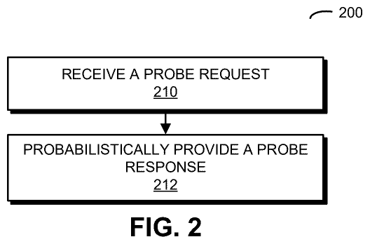

We now describe embodiments of the method. FIG. 2 presents an example of a flow diagram illustrating an example method 200 for probabilistically providing a probe response. Moreover, method 200 may be performed by an electronic device, such as one of access points 116 in FIG. 1, e.g., access point 116-1.

During operation, the electronic device may receive a probe request (operation 210) associated with a second electronic device, wherein the probe request comprises an identifier of the second electronic device (such as a MAC address). In response to receiving the probe request, the electronic device may probabilistically provide the probe response (operation 212) addressed to the second electronic device. Note that the probabilistically providing has a probability that is based at least in part on a communication-performance metric associated with the probe request, a predefined minimum value of the communication-performance metric and a predefined maximum value of the communication-performance metric.

The communication-performance metric may include a signal strength associated with the probe request, such as an RSSI.

Moreover, the predefined minimum value and the predefined maximum value may be based at least in part on an inter-electronic device communication-performance metric associated with communication between the electronic device and at least a neighboring electronic device. Furthermore, the inter-electronic device communication-performance metric may include a signal strength associated with the communication, such as an RSSI. Alternatively or additionally, the predefined minimum value and the predefined maximum value may be based at least in part on a density of the electronic device and the neighboring electronic device, and/or on a distance between the electronic device and the neighboring electronic device.

Furthermore, when the communication-performance metric may have a smaller value, the probability of providing the probe response is reduced.

In some embodiments of method 200, there may be additional or fewer operations. Moreover, there may be different operations. Furthermore, the order of the operations may be changed, and/or two or more operations may be combined into a single operation.

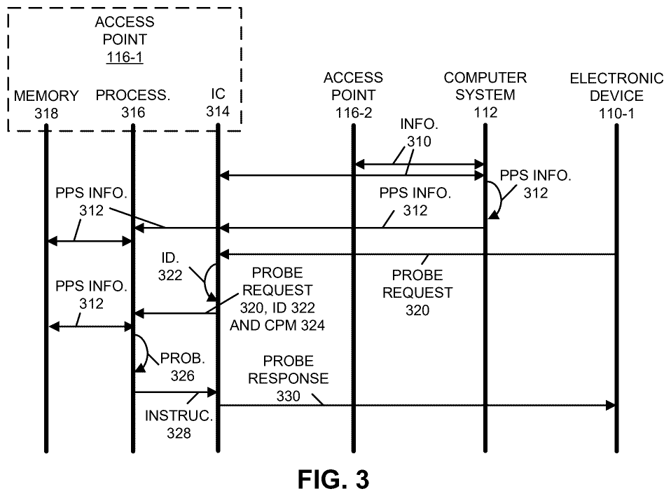

FIG. 3 presents a drawing illustrating an example of communication among electronic device 110-1, computer system 112, access point 116-1 and access point 116-2. During operation, computer system 112 may collect or aggregate information 310, such as network topology and/or historical communication data, from access points 116-1 and 116-2. Then, computer system 112 may determine probabilistic probe suppression (PPS) information 312, such as a predefined minimum value of a communication-performance metric and a predefined maximum value of the communication-performance metric based at least in part on the network topology and/or the historical communication data. Moreover, computer system 112 may provide, to access point 116-1, PPS information 312.

After receiving PPS information 312, interface circuit (IC) 314 in access point 116-1 may provide PPS information 312 to a processor 316 in access point 116-1, which may store PPS information 312 in memory 318 in access point 116-1.

Subsequently, electronic device 110-1 may provide a probe request 320 to access point 116-1. This probe request may include an identifier 322 of electronic device 110-1, such as a MAC address.

After receiving probe request 320, interface circuit 314 may provide probe request 320 and an associated communication-performance metric (CPM) 324 of probe request 320 (such as an RSSI) to processor 316. Then, processor 316 may access PPS information 312 in memory 318 based at least in part on identifier 322 and/or CPM 324. Moreover, processor 316 may calculate a probability 326 (between zero and one) of providing a probe response 328 based at least in part on PPS information 312 and CPM 324. For example, probability 326 may be calculated based at least in part on CPM 324, the predefined minimum value of the communication-performance metric and the predefined maximum value of the communication-performance metric. In some embodiments, when CPM 324 has a smaller value, probability 326 of providing probe response 328 may be reduced.

Next, processor 316 may instruct 330 interface circuit 314 to probabilistically provide probe response 328 addressed to electronic device 110-1 based at least in part on probability 326. For example, probability 326 may indicate a likelihood that interface circuit 314 provides probe response 328.

While FIG. 3 illustrates some operations using unilateral or bilateral communication (which are, respectively, represented by one-sided and two-sided arrows), in general a given operation in FIG. 3 may involve unilateral or bilateral communication.

We now further describe the communication techniques. These communication techniques use a PPS technique that exploits the local access-point density around the access points by analyzing the RSSI of access point-to-access point links. The technique may derive a probabilistic function (PPS function) for a given access point that decides the probability that the given access point will send a probe response given the RSSI of the probe request. The lower the RSSI of the probe request, the smaller may be the probability the given access point will send a probe response. The proposed PPS technique may provide a flexible tradeoff between the efficiency of probe suppression and client connectivity.

Current airtime decongestion (ATD) techniques are often based on a fixed RSSI threshold. For example, an access point may stop sending a probe response when the RSSI of a probe request falls below a threshold.

In general, the RSSI threshold may be determined automatically or may be set manually. An auto-threshold technique may be based on a number and strength of the neighboring access points. For Example, more and stronger (or closer) neighboring access points may lead to a higher threshold.

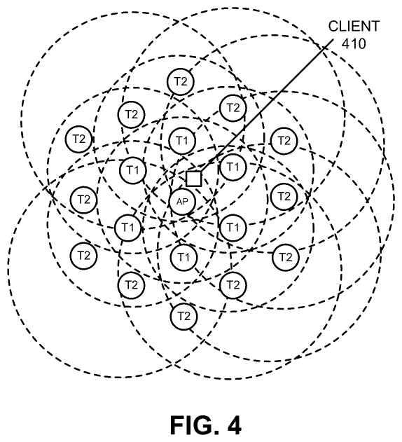

However, a fixed RSSI threshold may not be able to effectively reduce probe responses while guaranteeing client connectivity in a dense radio-frequency environment. As shown in FIG. 4, which presents a drawing illustrating an example of a wireless network, many access points may have a similar distance to a client 410, and the probe request from the client may have a similar RSSI value at these access points. In this case, on one hand, using a low RSSI threshold for ATD may not effectively reduce the probe responses (such as when the RSSI values of the probe requests are higher than the ATD RSSI threshold). Alternatively, using a high threshold for ATD may lead to all or most of the access points not sending probe responses and, thus, may cause connection difficulties for the client (such as when the RSSI values of the probe requests are lower than the ATD RSSI threshold).

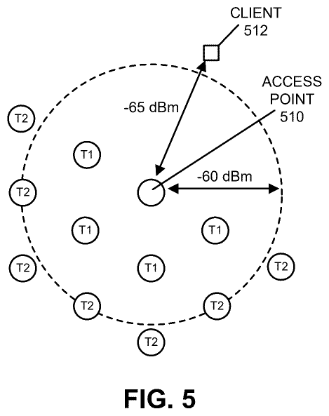

Moreover, a fixed RSSI threshold may not be able to adapt to radio-frequency environments in which the access-point density is uneven (e.g., at the edge of a wireless network) and may lead to coverage holes. As shown in FIG. 5, which presents a drawing illustrating an example of a wireless network, the auto-threshold technique of ATD may determine a high RSSI threshold of −60 dBm for target access point 510 based on the high local access-point density. In this case, client 512 from an area with lower access-point density may not be able to connect to the wireless network even if it has a decent RSSI value (e.g., −65 dBm).

### Probabilistic Probe Response (PPS)

In ATD, each access point may have its own probe-request RSSI threshold (rₜₕᵣ), and it may not send a probe response for a probe request when the RSSI value of the probe request (Freq) is lower than this threshold. In PPS, each access point may send probe responses for a probe request in a probabilistic manner, and the probability for sending the probe response may be determined based at least in part on: the local density/strength of neighboring access points; and the RSSI value of the probe request.

Notably, in general, an access point may send probe responses with a larger probability when there are few neighboring access points and/or the neighboring access points are far away from this access point (a low access point-to-access point RSSI). Alternatively, the access point may send probe responses with a smaller probability when there are more neighboring access points and/or the neighboring access points are nearby (high access points-to-access point RSSI). Moreover, the higher the RSSI value of the probe request, the greater the probability of sending a probe response.

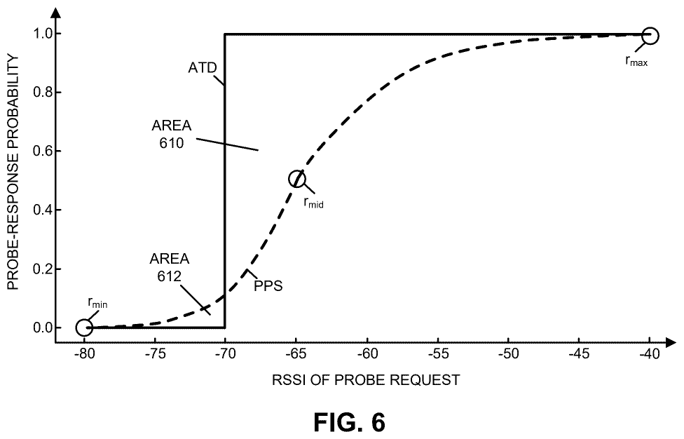

FIG. 6 presents a drawing illustrating an example of a probabilistic probe response. Notably, FIG. 6 shows a comparison of the probability of a certain access point sending probe responses with different r_{req}, by using ATD and PPS, respectively. In FIG. 6, we assume rₜₕᵣ equals −70 dBm. It can be seen that when r_{req} is less than −70 dBm, ATD would stop sending probe responses completely. Consequently, the probe-response probability p_{prob}(r_{req}) equals 0 when r_{req} is less than −70 dBm. Alternatively, when r_{req} is greater than or equal to −70 dBm, ATD would send probe responses constantly. Thus, p_{prob}(R_{req}) equals one when r_{req} is greater than or equal to −70 dBm.

As a comparison, PPS would stop sending probe responses only when r_{req} becomes really small and approaches rₘᵢₙ (the minimum RSSI for the network to provide a meaningful Wi-Fi connection) and, thus, p_{prob}(R_{req}) approaches 0 when r_{req} approaches rₘᵢₙ. PPS would send probe responses constantly only when r_{req} becomes really large and approaches max (the RSSI value at which this access point is confident that it is the best candidate access point to provide a Wi-Fi connection for this client) and, thus, p_{prob}(r_{req}) approaches one when r_{req} approaches rₘₐₓ. The probability of probe response p_{prob}(R_{req}) may increase smoothly from 0 to 1 as r_{req} increases from rₘᵢₙ to max.

In some embodiments, a modified Sigmoid function may define the PPS function p_{prob}(r_{req}, rₘᵢₙ, r_{mid}, rₘₐₓ), which may control the probability at which an access points sends a probe response for a probe request with an RSSI of Freq. Specifically,

$${p}_{p r o b} ( {r}_{req} , {r}_{min} , {r}_{mid} , {r}_{max} ) = \frac{1}{1 + {e}^{- α \cdot ( {r}_{req} - {r}_{mid} )}} ,$$

$$where$$

$$α = \{ \begin{matrix}\frac{C}{{r}_{max} - {r}_{mid}} & where {r}_{req} \geq {r}_{min} \\ \frac{C}{{r}_{mid} - {r}_{min}} & where {r}_{req} < {r}_{min}\end{matrix}$$

Note that a denotes a scaling factor of the modified Sigmoid function, and C denotes a constant having a predetermined value that controls a speed at which the probe response probability converges to 0 or 1 when it deviates from r_{mid}. In practice, C may be in the range of 5-10. The three parameters rₘᵢₙ, r_{mid}, and rₘₐₓ control the ‘aggressiveness’ of the PPS technique and are discussed further below. Note that in FIG. 6, the dotted line denotes p_{prob}(r_{req}, rₘᵢₙ equals −80 dBm, r_{mid} equals −65 dBm, rₘₐₓ equals −40 dBm).

Moreover, in FIG. 6, area 610 indicates scenarios in which PPS transmits fewer probe responses than ATD. On the other hand, area 612 indicates scenarios in which PPS needs to send more probe responses than ATD in order to provide a chance for the clients with r_{req} less than −70 dBm to connect to the access point. These clients would have no chance to connect to this access point with ATD.

The communication techniques may incorporate several tradeoffs. For example, there may be a tradeoff between the probe response and the coverage. Notably, as described in the previous example, PPS may guarantee a chance for a client to connect to an access point as long as r_{req} greater than or equal to Imin (thereby providing better coverage than ATD, which requires r_{req} greater than or equal to rₜₕᵣ). However, this is at the cost that this access point would need to send probe responses for the probe request with an r_{req} that is larger than rₘᵢₙ but smaller than rₜₕᵣ (and, thus, with a small probability).

Moreover, there may be a tradeoff between the probe response and the probe-request retry. Notably, with a probe request with very small r_{req} and/or an area with very low access-point density (e.g., few access points receive this probe request), it is possible that no access point decides to send a probe response for this probe request. In this case, the client may need to retry by sending another probe request.

Furthermore, there may be a tradeoff between the probe response and the connection RSSI. For example, when a probe request is sent by a client and received by multiple surrounding access points, each of these access points may send a probe response probabilistically based on its r_{req}. It is possible that the access point with largest r_{req} (e.g., access point 1) decides not to send a probe response (although, with a small probability). However, a few other access points with smaller r_{req} may send probe responses, among which access point 2 may have the largest r_{req}. In this case, the client may decide to connect to access point 2 instead of access point 1 and, therefore, may have a connection RSSI that is lower than the theoretically highest connection RSSI at this specific location.

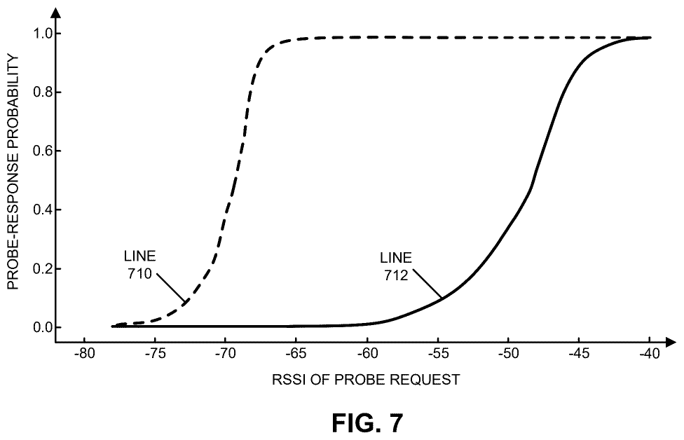

FIG. 7 presents a drawing illustrating examples of probabilistic probe responses. Notably, FIG. 7 shows two examples of the PPS function with different parameters. Line 710 for p_{prob}(r_{req}, rₘᵢₙ equal to −85 dBm, r_{mid} equal to −75 dBm, rₘₐₓ equal to −70 dBm) represents a configuration of PPS that is conservative on probe-response suppression, e.g., maintaining good coverage, low probe-request retries, and high connection RSSI may be given a higher priority than the efficiency of probe-response suppression. Alternatively, line 712 may for p_{prob}(r_{req}, rₘᵢₙ equal to −70 dBm, r_{mid} equal to −50 dBm, rₘₐₓ equal to −40 dBm) represents a configuration of PPS that is aggressive on probe-response suppression, e.g., the efficiency of probe-response suppression may be given a higher priority than maintaining good coverage, low probe-request retries, and high connection RSSI. We may be able to control the behavior (the ‘aggressiveness’ of PPS) for a particular access point smoothly by adjusting rₘᵢₙ, r_{mid}, and rₘₐₓ.

The adjustment of these parameters for a specific access point may take into account factors, such as: the radio-frequency neighborhood of a particular access point; and a nature of the deployment.

Regarding the radio-frequency neighborhood, when the local access-point density is high, one client may, most likely, be able to connect to one of the neighboring access points that has similar connection RSSI, even when this access point does not send a probe response. In this case, this access point may have the freedom to behave more ‘aggressively’ (e.g., suppressing more probe responses). Alternatively, when there are few or no neighboring access point(s) around, or all the neighboring access points are far away, one client may, most likely, not be able to connect to the network when this access point does not send a probe response. In this case, this access point may need to act more ‘conservatively’ (e.g., suppressing fewer probe responses).

Regarding the nature of the deployment, in an open and dense deployment (e.g., a stadium) with large number of clients, where excessive number of probe responses may be a major performance issue, the access point may behave more ‘aggressively’ (e.g., suppressing more probe responses). Alternatively, in a relatively sparse deployment with smaller number of clients, where excessive probe responses may not be a major performance issue, the access points may act more ‘conservatively’ (e.g., suppressing fewer probe responses). Even for the same deployment, the preference/requirement may change at different times. For example, in a stadium, the probe response suppression efficiency may be much more important during a sports game, when large number of clients are connecting to the network, than in the periods when there is no event going on, and the configuration of PPS may change accordingly.

In some embodiments, the communication techniques may involve determining the PPS function, e.g., p_{prob}(Freq, rₘᵢₙ, r_{mid}, rₘₐₓ) for each access point. Because we use a modified Sigmoid function to define p_{prob}(r_{req}, rₘᵢₙ, r_{mid}, rₘₐₓ), this may involve determing rₘᵢₙ, r_{mid} and rₘₐₓ for each access point.

rₘᵢₙ may be determined by analyzing the historical client connection data for a particular access point and let rₘᵢₙ=min(r_{C}), where r_{C} denotes the collection of the connection RSSI for all the historical connections. Alternatively, rₘᵢₙ may be defined as the minimum RSSI for this access point to provide a meaningful Wi-Fi connection, e.g., −80 dBm.

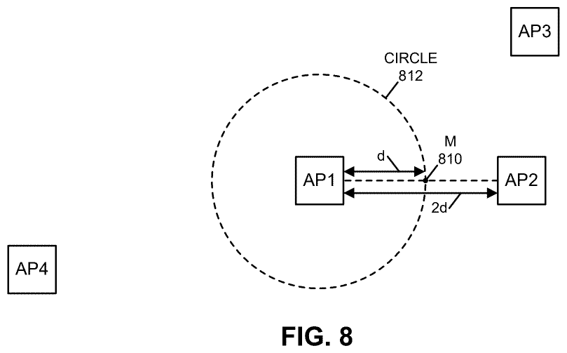

Moreover, rₘₐₓ may be decided by analyzing the radio-frequency neighborhood of a particular access point. In FIG. 8, which presents a drawing illustrating an example of a wireless network, we want to decide rₘₐₓ for access point 1. Among all the neighboring access points of access point 1, such as access point 2, access point 3, and access point 4, access point 2 is the closest one (with strongest access point-to-access point link with access point 1). The RSSI of the all access point-to-access point links may be obtained from the neighboring access-point report for this access point. We denote the RSSI for the link access point 1-to-access point 2 as r₁₂. Point M 810 denotes the middle point of link access point 1-to-access point 2. Based at least in part on the path-loss model, it can be derived that

$${r}_{M} = {r}_{12} + 10 \cdot N \cdot log ( 2 ) - {r}_{δ} ,$$

where r_{M} denotes r_{req} at access point 1 when the probe request is sent by a client at point M 810 (more specifically, at a distance of d from access point 1), N denotes the path-loss factor (e.g., 3), and rs denotes a constant value in dB that is used to compensate the RSSI difference of an access point and a client device. When access point 1 receives a probe request with r_{req} greater than r_{M}, access point 1 may know that the client is located within circle 812, and the distance from the client to access point 1 is smaller than the distance from the client to any neighboring access points. In other words, access point 1 may be confident that it is the best candidate access point for the client to connect to. Consequently, access point 1 may send probe responses with a probability of one. Therefore, we may define or set rₘₐₓ equal to r_{M} for access point 1.

Other than the distance between the transmitter and the receiver, the RSSI at an access point may also be influenced by various characteristics of the transmitter, including: the transmit power, antenna hardware design, device-mounting height, etc. For example, when an access point and a client device are co-located, and the RSSI at a common receiver access point may be denoted as r_{AP} and r_{client}, respectively. The difference of the RSSI may be denoted as:

$${r}_{δ} = {r}_{A P} - {r}_{c l i e n t} .$$

When r_{δ} is considered, r_{M} may represent the expected RSSI at access point 1 when a client transmits at point M 810. In practice, r_{δ} may be obtained by performing a calibration as described previously or by analyzing historical access point-to-access point RSSI and client-to-access point RSSI.

Note that with fixed values of rₘᵢₙ and rₘₐₓ, the value of r_{mid} may specify the ‘aggressiveness’ of PPS.

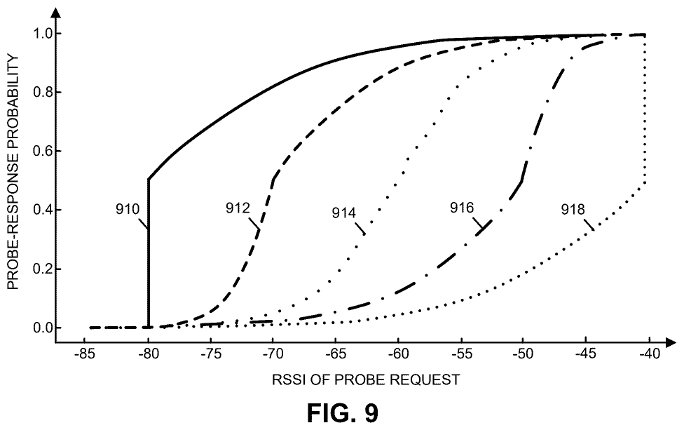

As can be seen in FIG. 9, which presents a drawing illustrating examples of probabilistic probe responses, with rₘᵢₙ equal −80 dBm, rₘₐₓ equal −40 dBm, and r_{mid} equal to: −80 dBm 910, −70 dBm 912, −60 dBm 914, −50 dBm 916, and −40 dBm 918. With min equal to −80 dBm and rₘₐₓ equal to −40 dBm, a larger Imin may result in more ‘aggressive’ behavior in probe-response suppression. Moreover, the closer r_{mid} is ‘pulled’ to rₘₐₓ the more ‘aggressive’ PPS is. Furthermore, the lower interval between Imin and r_{mid} may be defined as LI, and the upper interval between r_{mid} and rₘₐₓ may be defined as UI. We also may define the maximum allowed lower interval as LIₘₐₓ. The value of r_{mid} may then be calculated as

$${r}_{mid} = max ( {r}_{min} , min ( {r}_{min} + L {I}_{max} , {r}_{max} - U I ) ) ,$$

where the constraint of LIₘₐₓ is to avoid the scenario where r_{mid} is ‘pulled’ too far away from rₘᵢₙ because of a very large value of rₘₐₓ and/or a very small UI.

In general, the parameters for PPS are UI and LIₘₐₓ. A smaller value of UI and a larger value of LIₘₐₓ may lead to more ‘aggressive’ behavior of PPS and higher probe-suppression efficiency. Alternatively, a larger value of UI and a smaller value of LIₘₐₓ may lead to more ‘conservative’ behavior of PPS and lower probe-suppression efficiency. In practice, a value of UI may be in the range of 10-30 dBm, and a value of LIₘₐₓ may be in the range of 0-20 dBm. In embodiments where min is manually set or defined, it becomes a parameter, and a typical value may be −80 dBm.

The communication techniques may include a learning phase and an online phase. During the learning phase, a cloud-based computer system (such as computer system 112 in FIG. 1) may collect topology and/or historical data for access points in a network. Then, the cloud-based computer system may determine or calculate rₘᵢₙ, r_{mid} and Imax for each access point, and may provide the determined values to each of the access points. After receiving the determined values, each of the access points may use its values of rₘᵢₙ, r_{mid} and rₘₐₓ to generate its PPS function p_{prob}(r_{req}, rₘᵢₙ, r_{mid}, rₘₐₓ) and to form a lookup table that maps every possible r_{req} to the corresponding probability of sending a probe response. This lookup table may be stored in memory in a given access point for use when deciding whether to respond to a probe request having an associated RSSI.

Moreover, during the online phase, when an access point receives a probe request, it may obtain the probability (between zero and one) of sending a probe response p_{prob}(r_{req}, rₘᵢₙ, r_{mid}, rₘₐₓ) based at least in part on the predetermined or predefined lookup table. Next, the access point may send a probe response with a probability p_{prob}(r_{req}, rₘᵢₙ, Imid, rₘₐₓ).

We now describe embodiments of an electronic device, which may perform at least some of the operations in the communication techniques. For example, the electronic device may: base station 108, one of electronic devices 110, computer system 112, one of access points 116, one of radio nodes 118, and/or switch 128. FIG. 10 presents a block diagram illustrating an electronic device 1000 in accordance with some embodiments. This electronic device includes processing subsystem 1010, memory subsystem 1012, and networking subsystem 1014. Processing subsystem 1010 includes one or more devices configured to perform computational operations. For example, processing subsystem 1010 can include one or more microprocessors, ASICs, microcontrollers, programmable-logic devices, graphical processor units (GPUs) and/or one or more digital signal processors (DSPs).

Memory subsystem 1012 includes one or more devices for storing data and/or instructions for processing subsystem 1010 and networking subsystem 1014. For example, memory subsystem 1012 can include dynamic random access memory (DRAM), static random access memory (SRAM), and/or other types of memory (which collectively or individually are sometimes referred to as a ‘computer-readable storage medium’). In some embodiments, instructions for processing subsystem 1010 in memory subsystem 1012 include: one or more program modules or sets of instructions (such as program instructions 1022 or operating system 1024), which may be executed by processing subsystem 1010.

Note that the one or more computer programs may constitute a computer-program mechanism. Moreover, instructions in the various modules in memory subsystem 1012 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1010.

In addition, memory subsystem 1012 can include mechanisms for controlling access to the memory. In some embodiments, memory subsystem 1012 includes a memory hierarchy that comprises one or more caches coupled to a memory in electronic device 1000. In some of these embodiments, one or more of the caches is located in processing subsystem 1010.

In some embodiments, memory subsystem 1012 is coupled to one or more high-capacity mass-storage devices (not shown). For example, memory subsystem 1012 can be coupled to a magnetic or optical drive, a solid-state drive, or another type of mass-storage device. In these embodiments, memory subsystem 1012 can be used by electronic device 1000 as fast-access storage for often-used data, while the mass-storage device is used to store less frequently used data.

Networking subsystem 1014 includes one or more devices configured to couple to and communicate on a wired and/or wireless network (i.e., to perform network operations), including: control logic 1016, an interface circuit 1018 and one or more antennas 1020 (or antenna elements). (While FIG. 10 includes one or more antennas 1020, in some embodiments electronic device 1000 includes one or more antenna nodes, such as nodes 1008, e.g., a pad or connector, which can be coupled to the one or more antennas 1020. Thus, electronic device 1000 may or may not include the one or more antennas 1020.) For example, networking subsystem 1014 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 1000 may be adapted or changed using pattern shapers (such as reflectors) in one or more antennas 1020 (or antenna elements), which can be independently and selectively electrically coupled to ground to steer the transmit antenna radiation pattern in different directions. Thus, if one or more antennas 1020 includes N antenna-radiation-pattern shapers, the one or more antennas 1020 may have 2N different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 1014 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1000 may use the mechanisms in networking subsystem 1014 for performing simple wireless communication between the electronic devices, e.g., transmitting frames and/or scanning for frames transmitted by other electronic devices.

Within electronic device 1000, processing subsystem 1010, memory subsystem 1012, and networking subsystem 1014 are coupled together using bus 1028. Bus 1028 may include an electrical, optical, and/or electro-optical connection that the subsystems can use to communicate commands and data among one another. Although only one bus 1028 is shown for clarity, different embodiments can include a different number or configuration of electrical, optical, and/or electro-optical connections among the subsystems.

In some embodiments, electronic device 1000 includes a display subsystem 1026 for displaying information on a display, which may include a display driver and the display, such as a liquid-crystal display, a multi-touch touchscreen, etc.

Electronic device 1000 can be (or can be included in) any electronic device with at least one network interface. For example, electronic device 1000 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 1000, in alternative embodiments, different components and/or subsystems may be present in electronic device 1000. For example, electronic device 1000 may include one or more additional processing subsystems, memory subsystems, networking subsystems, and/or display subsystems. Additionally, one or more of the subsystems may not be present in electronic device 1000. Moreover, in some embodiments, electronic device 1000 may include one or more additional subsystems that are not shown in FIG. 10. Also, although separate subsystems are shown in FIG. 10, in some embodiments some or all of a given subsystem or component can be integrated into one or more of the other subsystems or component(s) in electronic device 1000. For example, in some embodiments program instructions 1022 are included in operating system 1024 and/or control logic 1016 is included in interface circuit 1018.

Moreover, the circuits and components in electronic device 1000 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 1014 or electronic device 1000. The integrated circuit may include hardware and/or software mechanisms that are used for transmitting wireless signals from electronic device 1000 and receiving signals at electronic device 1000 from other electronic devices. Aside from the mechanisms herein described, radios are generally known in the art and hence are not described in detail. In general, networking subsystem 1014 and/or the integrated circuit can include any number of radios. Note that the radios in multiple-radio embodiments function in a similar way to the described single-radio embodiments.

In some embodiments, networking subsystem 1014 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 1022, operating system 1024 (such as a driver for interface circuit 1018) or in firmware in interface circuit 1018. Alternatively or additionally, at least some of the operations in the communication techniques may be implemented in a physical layer, such as hardware in interface circuit 1018.

Additionally, while the preceding embodiments illustrated the use of wireless signals in one or more bands of frequencies, in other embodiments of these signals may be communicated in one or more bands of frequencies, including: a microwave frequency band, a radar frequency band, 900 MHZ, 2.4 GHz, 5 GHz, 60 GHz, and/or a band of frequencies used by a Citizens Broadband Radio Service or by LTE. In some embodiments, the communication between electronic devices uses multi-user transmission (such as OFDMA).

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate using wireless communication with a second electronic device, wherein the electronic device is configured to perform operations comprising:
receiving, from the interface circuit, a probe request associated with the second electronic device, wherein the probe request comprises an identifier of the second electronic device; and
in response to receiving the probe request, probabilistically providing, from the interface circuit, a probe response addressed to the second electronic device, wherein the probabilistically providing has a probability that is based at least in part on a communication-performance metric associated with the probe request, a predefined minimum value of the communication-performance metric and a predefined maximum value of the communication-performance metric.

2. The electronic device of claim 1, wherein the electronic device comprises an access point.

3. The electronic device of claim 1, wherein the communication-performance metric comprises a signal strength associated with the probe request.

4. The electronic device of claim 3, wherein the signal strength comprises a received signal strength indication (RSSI).

5. The electronic device of claim 1, wherein the predefined minimum value and the predefined maximum value are based at least in part on an inter-electronic device communication-performance metric associated with communication between the electronic device and at least a neighboring electronic device.

6. The electronic device of claim 1, wherein the inter-electronic device communication-performance metric comprises a signal strength associated with the communication.

7. The electronic device of claim 6, wherein the signal strength comprises a received signal strength indication (RSSI).

8. The electronic device of claim 1, wherein the predefined minimum value and the predefined maximum value are based at least in part on a density of the electronic device and the neighboring electronic device, a distance between the electronic device and the neighboring electronic device, or both.

9. The electronic device of claim 1, wherein, when the communication-performance metric has a smaller value, the probability of providing the probe response is reduced.

10. A non-transitory computer-readable storage medium for use in conjunction with an electronic device, the computer-readable storage medium storing program instructions, wherein, when executed by the electronic device, the program instructions cause the electronic device to perform one or more operations comprising:
receiving a probe request associated with a second electronic device, wherein the probe request comprises an identifier of the second electronic device; and
in response to receiving the probe request, probabilistically providing a probe response addressed to the second electronic device, wherein the probabilistically providing has a probability that is based at least in part on a communication-performance metric associated with the probe request, a predefined minimum value of the communication-performance metric and a predefined maximum value of the communication-performance metric.

11. The non-transitory computer-readable storage medium of claim 10, wherein the electronic device comprises an access point.

12. The non-transitory computer-readable storage medium of claim 10, wherein the communication-performance metric comprises a signal strength associated with the probe request.

13. The non-transitory computer-readable storage medium of claim 10, wherein, when the communication-performance metric has a smaller value, the probability of providing the probe response is reduced.

14. A method for probabilistically providing a probe response, comprising:
by an electronic device:
receiving a probe request associated with a second electronic device, wherein the probe request comprises an identifier of the second electronic device; and
in response to receiving the probe request, probabilistically providing the probe response addressed to the second electronic device, wherein the probabilistically providing has a probability that is based at least in part on a communication-performance metric associated with the probe request, a predefined minimum value of the communication-performance metric and a predefined maximum value of the communication-performance metric.

15. The method of claim 14, wherein the electronic device comprises an access point.

16. The method of claim 14, wherein the communication-performance metric comprises a received signal strength indication (RSSI) associated with the probe request.

17. The method of claim 14, wherein the predefined minimum value and the predefined maximum value are based at least in part on an inter-electronic device communication-performance metric associated with communication between the electronic device and at least a neighboring electronic device.

18. The method of claim 14, wherein the inter-electronic device communication-performance metric comprises a received signal strength indication (RSSI) associated with the communication.

19. The method of claim 14, wherein the predefined minimum value and the predefined maximum value are based at least in part on a density of the electronic device and the neighboring electronic device, a distance between the electronic device and the neighboring electronic device, or both.

20. The method of claim 14, wherein, when the communication-performance metric has a smaller value, the probability of providing the probe response is reduced.
